(19) United States
(12) Patent Application Publication
(10) Pub. No.: US 2017/0276897 A1
(43) Pub. Date: Sep. 28, 2017

(54) ENHANCED LENS ASSEMBLY

(71) Applicants: Ravi Nalla, San Jose, CA (US); Pierre Henri Rene Della nave, Seattle, WA (US); Kevin James Matherson, Windsor, CO (US)

(72) Inventors: Ravi Nalla, San Jose, CA (US); Pierre Henri Rene Della nave, Seattle, WA (US); Kevin James Matherson, Windsor, CO (US)

(21) Appl. No.: 15/081,769

(22) Filed: Mar. 25, 2016

(51) Int. Cl. G02B 7/02; B29C 65/00; B29C 65/16; G02B 7/00; B29C 65/48

(52) U.S. Cl. CPC G02B 7/028; G02B 7/021; G02B 7/025; G02B 7/003; B29C 65/48; B29C 65/16; B29C 66/742; B29K 2705/00

(57) ABSTRACT

Technologies described herein provide an enhanced lens assembly. In some configurations, a lens assembly includes a barrel configured with a number of components arranged therein. The components include at least a first lens, a second lens and a spacer positioned between the lenses. At least one lens is fastened to the barrel by one or more techniques, which may include the application of an adhesive to hold the lens in a predetermined location within the barrel. In other techniques, a lens is fastened to the barrel by the use of a laser or other like device configured to weld the lens to the barrel. In some configurations, the first lens and the second lens can be separated by a spacer that is made from a material having a linear thermal expansion coefficient within a predetermined range.

### BACKGROUND

With the continuous advancement of optical and computer technologies, electronic products such as imaging camera modules are in widespread use. A lens assembly is a key component of an imaging camera module. A typical lens assembly includes a barrel and a number of components, such as, and not limited to, lenses, spacers and filters. Generally, the components are compacted together in the barrel. Such configurations enable an imaging camera module to generate image data from a spectrum of light.

Although current technologies can enable an imaging camera module to produce image data suitable for most needs, in some current technologies, the image quality can be impacted by temperature fluctuations. When an imaging camera module is exposed to a temperature change, due to the thermal expansion mismatches of the various components, such as the lenses or spacers, a lens may shift and/or tilt and cause a field of view shift error. Some software technologies can be implemented to mitigate such issues, however, such solutions require additional processing power and such solutions can also cause a delay in the generation of the image data. In addition, some existing software solutions may not fully correct the issues caused by a field of view shift error.

The disclosure made herein is presented with respect to these and other considerations. It is with respect to these and other considerations that the disclosure made herein is presented.

### SUMMARY

Technologies described herein provide an enhanced lens assembly. In some configurations, a lens assembly includes a barrel configured with a number of components arranged therein. The components include at least a first lens, a second lens and a spacer positioned between the lenses. In some configurations, at least one lens is fastened to the barrel by one or more techniques disclosed herein. A lens can be fastened to a barrel using a number of suitable techniques, which may include the application of an adhesive to hold the lens in a predetermined position within the barrel. In other techniques, a lens is fastened to the barrel by the use of a laser or other like device configured to weld the lens to the barrel.

In some configurations, the first lens and the second lens can be separated by a spacer that is made from a material having a linear thermal expansion coefficient within a predetermined range, e.g., below a threshold. In some configurations, the spacer can be made from nickel, stainless steel, and other like materials. The techniques disclosed herein can be applied to a lens assembly having any suitable number of lenses and any suitable number of spacers, wherein at least one lens can be fastened to the barrel and/or at least one spacer comprises a material having a thermal expansion coefficient within a predetermined range.

These and various other features will be apparent from a reading of the following Detailed Description and a review of the associated drawings. This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is an exploded view of a lens assembly configured according to the techniques disclosed herein;

FIG. 2 is a cross-section of a lens assembly shown in FIG. 1;

FIG. 3 is a cross-section of a lens assembly comprising a fastening material configured to hold a lens in a predetermined position within a barrel;

FIG. 4 is a cross-section of a lens assembly comprising fastening materials configured to hold one lens and another lens in predetermined positions within a barrel;

FIG. 5 is a cross-section of a lens assembly comprising fastening materials configured to hold more than two lenses in predetermined positions within a barrel;

FIGS. 6A and 6B are cross-sections of a lens assembly comprising a fastening material that is applied through an opening through a barrel of the lens assembly;

FIG. 7 is a cross-section of a lens assembly comprising fastening materials configured to hold each lens in predetermined positions within a barrel;

FIG. 8 is a cross-section of a lens assembly comprising fastening materials configured to hold a first lens and a second lens in predetermined positions within a barrel;

FIG. 9 is a cross-section of a lens assembly comprising a barrel having an annular groove for receiving and holding fastening materials configured to hold a first lens and a second lens in predetermined positions within the barrel; and

FIG. 10 is a flow diagram of a process for providing a lens assembly configured with the techniques disclosed herein.

### DETAILED DESCRIPTION

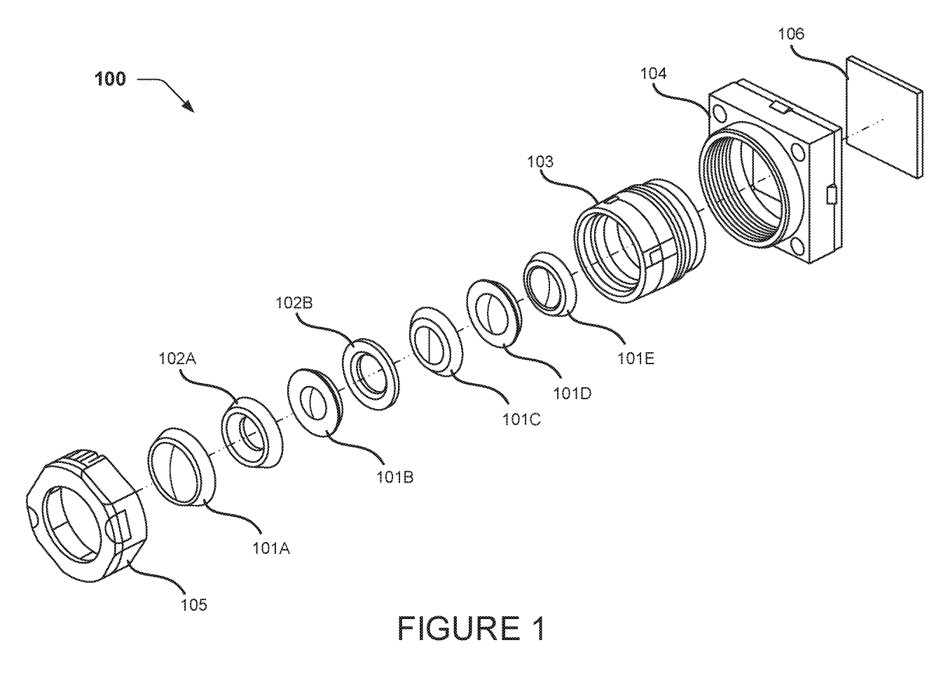

With reference to FIG. 1, an example lens assembly 100 is shown and described below. In this illustrative example, the lens assembly 100 comprises a first lens 101A, a second lens 101B, a third lens 101C, a fourth lens 101D, and a fifth lens 101E, which are generically referred to as “lenses 101” and individually referred to as a “lens 101.” The lens assembly 100 also comprises a first spacer 102A and a second spacer 102B, which are generically referred to as “spacers 102” and individually referred to as a “spacer 102.” In this example, the lens assembly 100 also comprises a barrel 103, a housing 104, a cap 105, and a sensor 106. This example is provided for illustrative purposes and is not to be construed as limiting. It can be appreciated that a lens assembly 100 can include any suitable number of lenses 101 and any suitable number of spacers 102.

As will be described below, the techniques disclosed herein involve configurations of a lens assembly 100 comprising one or more lenses 101 that are fastened to a predetermined position within a barrel 103. The techniques disclosed herein also involve configurations of a lens assembly 100 comprising spacers 102 having a linear thermal expansion coefficient within a predetermined range. The predetermined range can include values below a threshold. The configurations disclosed herein also include a lens assembly 100 comprising one or more fastening materials for holding at least one lens 101 to a fixed location and at least one spacer 102, positioned between a lens pair, where the spacer 102 has a linear thermal expansion coefficient within a predetermined range.

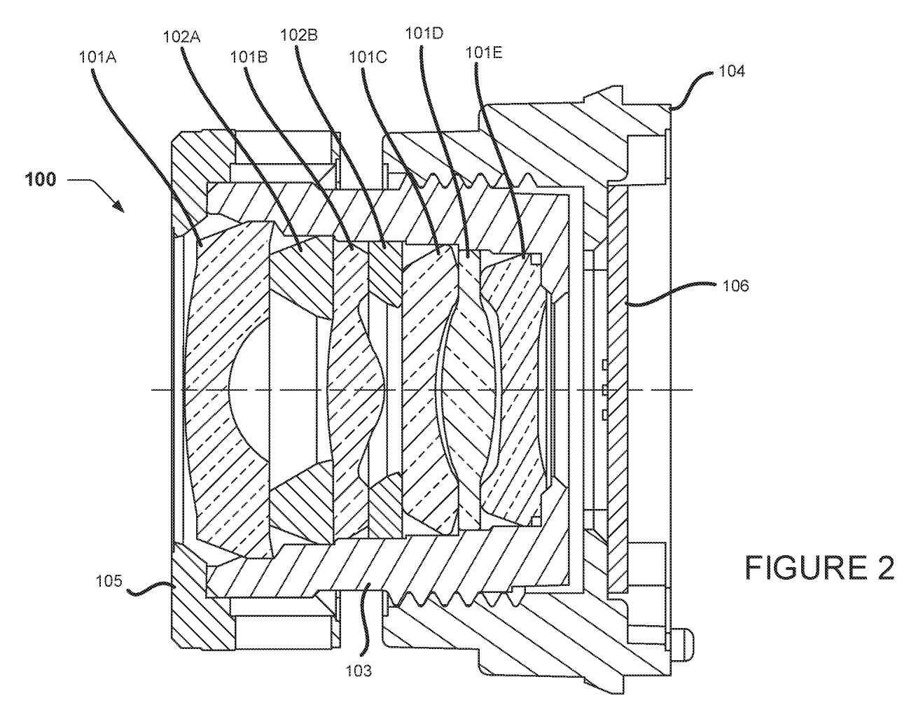

FIG. 2 illustrates a cross-section of the lens assembly 100 shown in FIG. 1. In this example, the first spacer 102A is positioned between the first lens 101A and the second lens 101B. The second spacer 102B is positioned between the second lens 101B and the third lens 101C. As shown, the barrel 103, housing 104, and cap 105 are configured to hold the lenses 101, spacers 102, and the sensor 106 in position as shown and described. Each individual lens 101 is configured to direct light through an optically active portion having an optical axis (shown by the dashed centerline). The optical axis of each lens 101 can be aligned as shown.

In the example of FIG. 2, the lens assembly 100 comprises spacers 102 having a linear thermal expansion coefficient within a predetermined range. In some configurations, the predetermined range of the linear thermal expansion coefficient of a spacer 102 can be less than a threshold of 30 ppm/° C. Other thresholds can be used depending on a desired application. Examples of materials comprising this characteristic can include metals, such as, but not limited to, iron, nickel, titanium, tungsten, and zinc. Alloys of various metals, such as, but not limited to, brass, bronze, and stainless steel, can also be used to form one or more spacers 102. Spacers 102 that comprise such materials, and other materials having similar characteristics, expand in a direction that is parallel to the axis within a predetermined range or below a threshold level, thereby increasing the stability of the components. It can be appreciated that the lens assembly 100 can include more or fewer spacers 102 than shown in this example. It can also be appreciated that the lens assembly 100 can include spacers 102 each with similar, identical, or different linear thermal expansion coefficients. For example, some spacers 102 may comprise a metal, and other spacers 102 may comprise one or more plastics. In one illustrative example, each spacer 102 of the lens assembly 100 all comprise a metal having a linear thermal expansion coefficient below a threshold level.

As summarized above, in addition to providing spacers 102 having a linear thermal expansion coefficient within a predetermined range, the techniques disclosed herein also provide a lens assembly having components, e.g., lenses, that are fastened in a predetermined position. The techniques for fastening a component in a predetermined position can be used in conjunction with spacers 102 having a thermal expansion coefficient within a predetermined range. Alternatively, the techniques for fastening a component in a predetermined position can be used with other types of spacers.

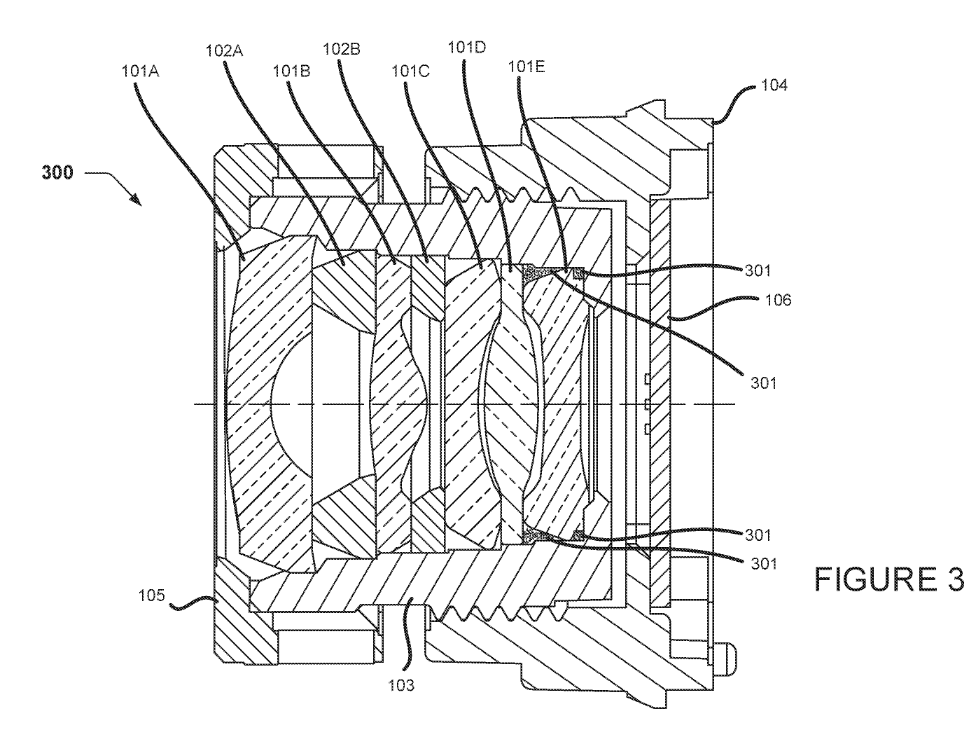

Referring now to FIG. 3, one example configuration of the lens assembly 300 is shown and described below. In this example, at least one lens 101 is fastened to the barrel 103 by the use of a fastening material 301. Specifically, as shown, the fifth lens 101E is fastened to the barrel 103. In this example, the lens assembly 100 can comprise spacers 102 having a linear thermal expansion coefficient within a predetermined range. As described herein, the predetermined range can include a linear thermal expansion coefficient above or below a threshold.

The fastening material 301 can include any suitable material for securing a lens 101 in a position within the barrel 103. For example, the fastening material 301 can comprise any suitable adhesive, such as an epoxy. Examples of other fastening materials can include, but are not limited to, acrylates, cyanoacrylates, phenol-formaldehyde, polyvinyl chlorides, silicones, and urethanes. These examples are provided for illustrative purposes and are not to be construed as limiting, as it can be appreciated that any suitable material, including a mechanical device, can be used to fasten a lens 101 to a barrel 103.

In some configurations, the fastening material 301 can be formed by a process, such as the application of a laser. In such configurations, a laser can be applied to an area where a lens 101 makes contact with the barrel 103. In one illustrative example, a diode laser, such as one having a laser in the range of 800 nm-1470 nm, can be used to weld the lens 101 and the barrel 103 together. Other suitable devices that can cause the lens 101 and the barrel 103 to fuse together can be utilized.

In the example of FIG. 3, the fifth lens 101E is fastened to the housing 103 by the use of an adhesive. The adhesive can be applied to an area between the fifth lens 101E and the barrel 103. The adhesive can be applied before and/or after the fifth lens 101E is placed in position. A welding process or other like process can also create a fastening material 301, e.g., a weld, between the fifth lens 101E and the barrel 103. When a welding process is utilized, a lens, such as the fifth lens 101E, can be welded to the barrel 103 prior to the insertion of the other components, such as the first lens 101A, second lens 101B, third lens 101C, fourth lens 101D, and the two spacers 102. In such an example, the weld could be positioned on the left side of the fifth lens 101E as shown in FIG. 3. In some configurations, different types of fastening materials 301 can be combined. For instance, with reference to FIG. 3, an adhesive can be used on the right side of the fifth lens 101E, and a weld can be used on the left side of the fifth lens 101E.

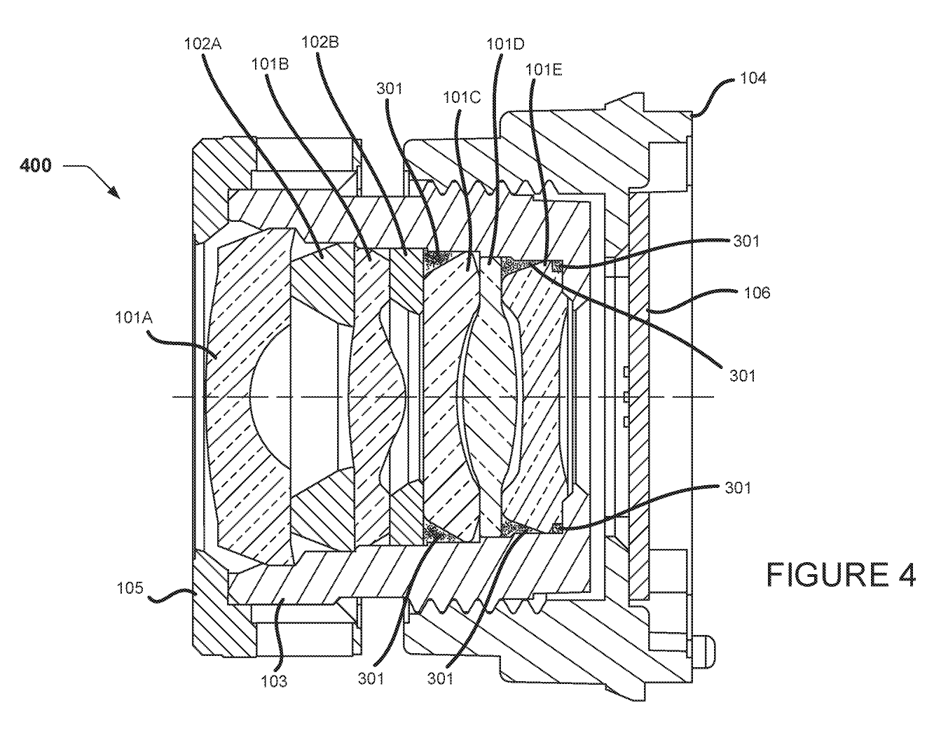

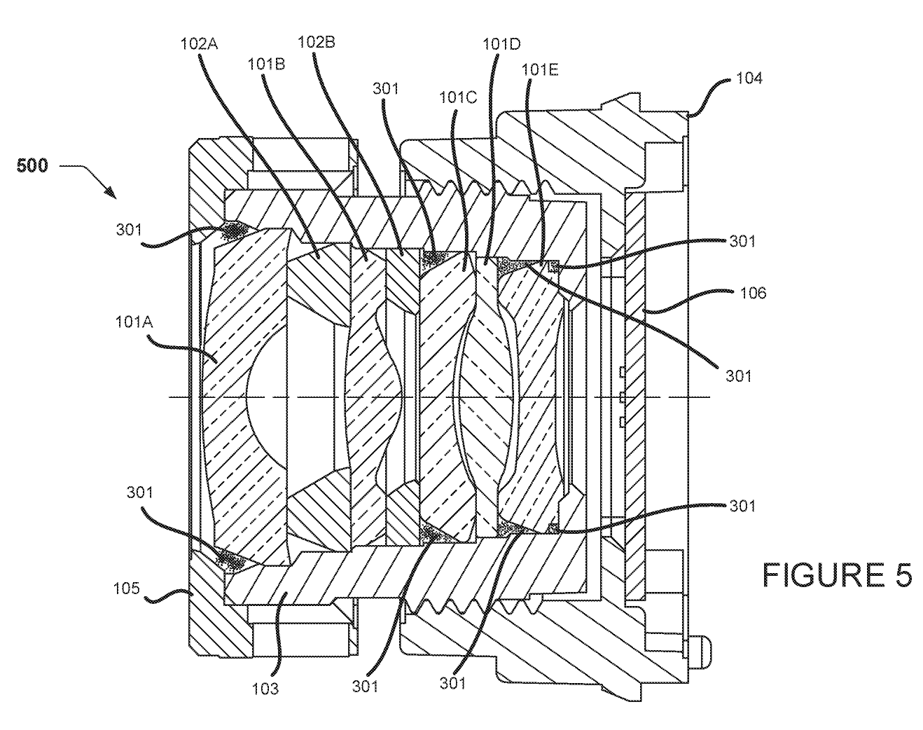

As summarized above, any lens 101 or any combination of lenses 101 can be fastened to the barrel 103. For illustrative purposes, the example of FIG. 4 shows a lens assembly 400 comprising fastening materials 301 configured to fasten the third lens 101C and the fifth lens 101E to the barrel 103. In the example of FIG. 5, a lens assembly 500 comprises fastening materials 301 configured to fasten the first lens 101A, the third lens 101C and the fifth lens 101E to the barrel 103. In these examples, the lens assemblies (400 and 500) can comprise spacers 102 having a linear thermal expansion coefficient within a predetermined range. As described herein, the predetermined range can include a linear thermal expansion coefficient below a threshold, such as those described herein.

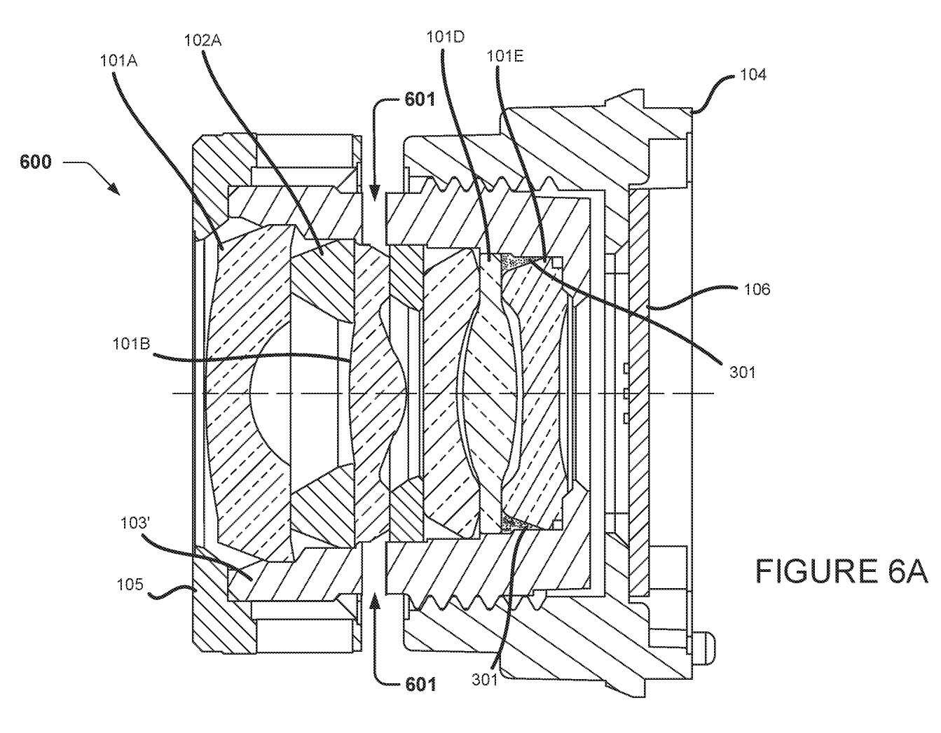

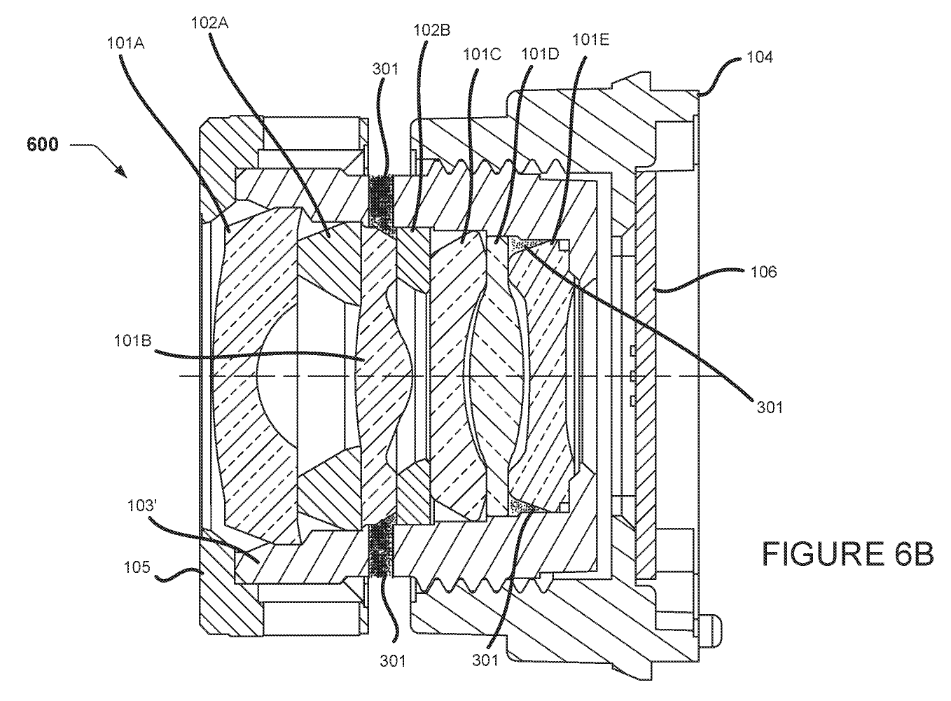

In some configurations, a fastening material 301 can be applied to the lens assembly 100 through one or more openings in the barrel 103. FIG. 6A illustrates one example lens assembly 600 having a barrel 103′ configured with several openings 601. The barrel 103′ can include any number of openings 601 having suitable size and shape for allowing the passage of a fastening material 301 through the barrel 103′ to a region of the barrel 103′ where a lens makes contact with the barrel 103′. A fastening material, such as an adhesive, can be applied through the opening 601 such that the fastening material 301 makes contact with at least one lens and the barrel 103′. An opening may also be sized and shaped to enable a welding device to access a region where a lens comes in contact with a barrel.

FIG. 6B illustrates one example where a fastening material 301 is applied through the openings 601 of the barrel 103′. In this example, the fastening material 301 makes is in contact with the second lens 101B and the barrel 103′ such that the second lens 101B is held in a position within the barrel 103′. The fastening material 301 can also be applied such that the fastening material 301 seals the openings 601.

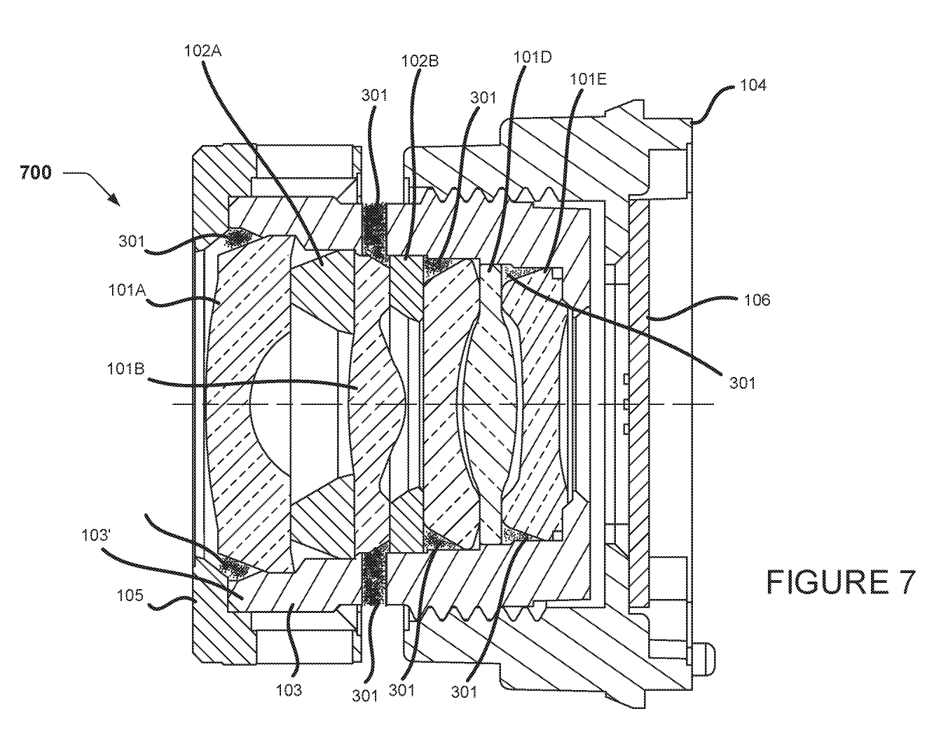

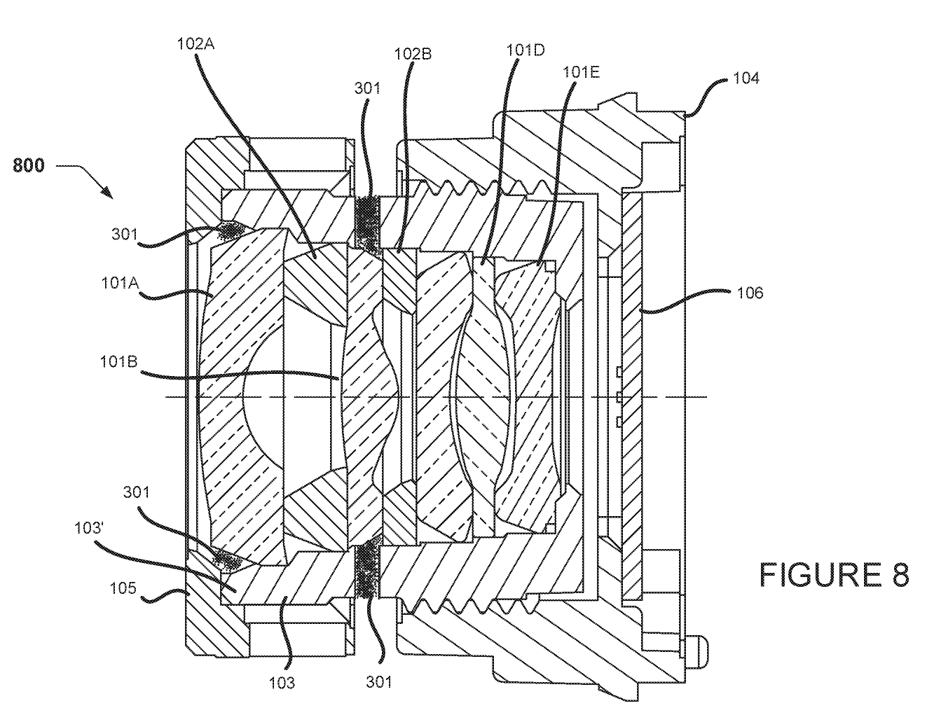

For illustrative purposes, the example of FIG. 7 shows a lens assembly 700 comprising fastening materials 301 configured to affix the first lens 101A, the second lens 101B, the third lens 101C, and the fifth lens 101E to the barrel 103′. In the example of FIG. 8, a lens assembly 800 comprises fastening materials 301 configured to affix the first lens 101A and the second lens 101B to the barrel 103′. In this example, the first lens 101A is secured in a first position within the barrel 103′ by the use of a fastening material 301, and the first lens 101A has a first optically active portion having a first optical axis. The second lens 101B is secured in a second position within the barrel 103′ by the use of a fastening material 301. The second lens 101B has a second optically active portion having a second optical axis that is aligned with the first optical axis of the first lens 101A. In these examples, the lens assemblies (700 and 800) can comprise spacers 102 having a linear thermal expansion coefficient within a predetermined range. As described herein, the predetermined range can include a linear thermal expansion coefficient above or below a threshold.

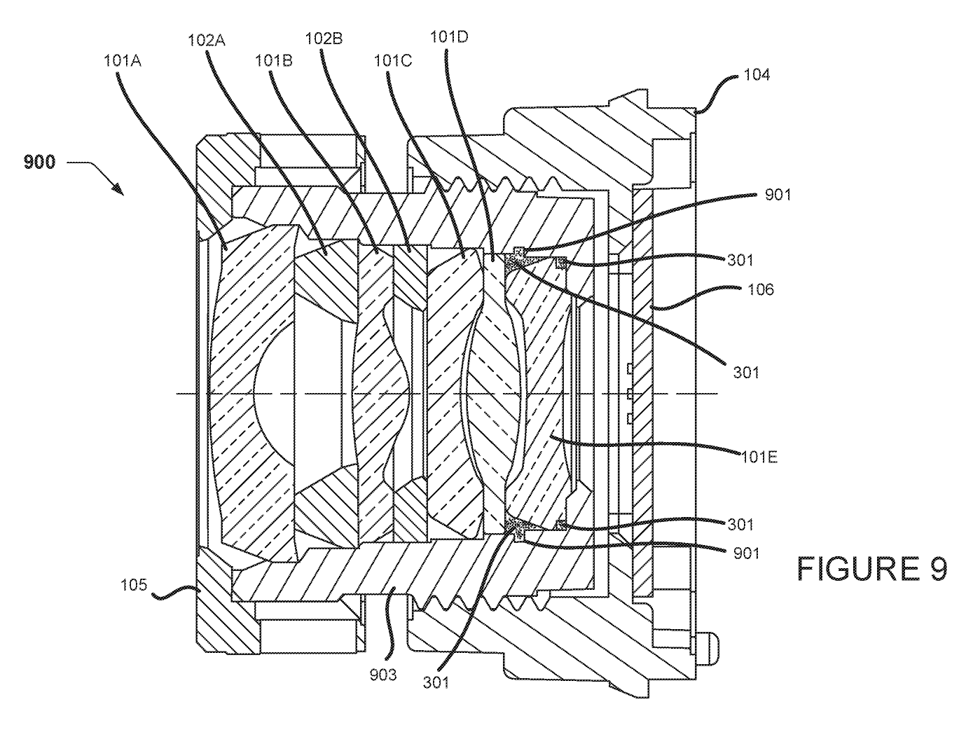

In some configurations, the barrel 103 comprises an annular groove or a channel configured to receive and hold a fastening material. FIG. 9 shows one example of a lens assembly 900 having an annular groove 901 formed in the barrel 903. As shown, the annular groove 901 is sized to receive and hold a fastening material 301 in a region where at least one lens makes contact with the barrel 903. In some configurations, the annular groove 901 can also be sized and configured to receive at least a portion of a lens.

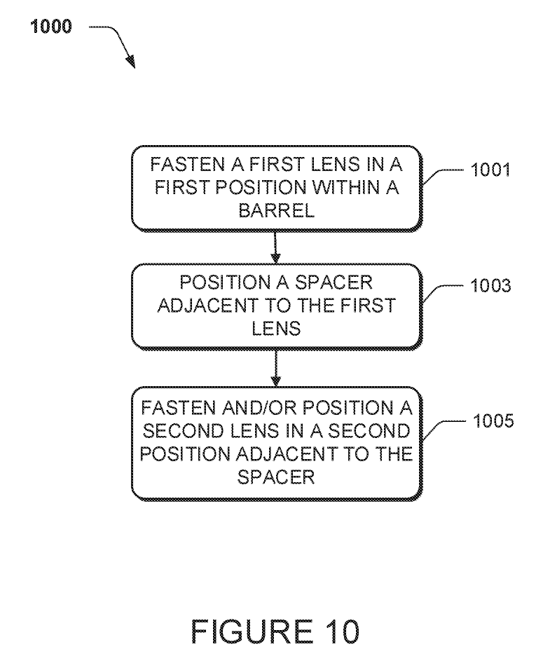

Referring now to FIG. 10, aspects of an example process 1000 for forming a lens assembly are shown and described below. Aspects of such techniques, and other techniques disclosed herein, can also be used for forming a stand-alone structure that can be placed into a device or other article of manufacture.

The process 1000 starts at stage 1001 where a first lens is fastened to a first position within a barrel. As described above, a lens can be fastened to a barrel using a number of suitable techniques. Stage 1001 can include the application of an adhesive between the lens and the barrel and/or the application of a welding tool to fuse the lens to the barrel. A fastening material can be applied to the lens and the barrel through an opening in the barrel.

Next, at stage 1003, a spacer is positioned adjacent to the first lens. The spacer can be made from any suitable material. In some configurations, the spacer comprises a material having a thermal expansion coefficient lower than a threshold level. In some configurations, the spacer comprises a material having a thermal expansion coefficient within a predetermined range. The spacer can include at least one of titanium, nickel, brass, copper, other metals having a similar thermal expansion coefficient, or a combination thereof. In some configurations, the thermal expansion coefficient can be below 30 ppm/T.

Next, at stage 1005, a second lens is placed in a second position that is adjacent to the spacer. In some configurations, the second lens is placed in the second position without a fastening material. In some configurations, the second lens is fastened in the second position with a fastening material. When a fastening material is utilized, the second lens can be fastened by any suitable material and utilizing any suitable techniques, including those disclosed herein.

Based on the foregoing, it should be appreciated that concepts and technologies have been disclosed herein that provide an enhanced lens assembly. Although the subject matter presented herein has been described in language specific to some structural features, methodological and transformative acts, and specific machinery, it is to be understood that the invention defined in the appended claims is not necessarily limited to the specific features or acts described herein. Rather, the specific features and acts are disclosed as example forms of implementing the claims.

The subject matter described above is provided by way of illustration only and should not be construed as limiting. Various modifications and changes may be made to the subject matter described herein without following the example configurations and applications illustrated and described, and without departing from the true spirit and scope of the present invention, which is set forth in the following claims.

What is claimed is:

1. A lens assembly, comprising:
a barrel;
a first lens fastened in a first position within the barrel, wherein the first lens has a first optically active portion having a first optical axis;
a second lens fastened in a second position within the barrel, wherein the second lens has a second optically active portion having a second optical axis that is aligned with the first optical axis; and
a spacer positioned between the first lens and the second lens, wherein the spacer comprises a material having a thermal expansion coefficient lower than a threshold level.

2. The lens assembly of claim 1, wherein the first lens is fastened in the first position by an adhesive.

3. The lens assembly of claim 1, wherein the second lens is fastened in the second position by an adhesive.

4. The lens assembly of claim 1, wherein the first lens is fastened in the first position by a weld formed between the first lens and the barrel.

5. The lens assembly of claim 1, wherein the second lens is fastened in the second position by a weld formed between the first lens and the barrel.

6. The lens assembly of claim 1, wherein the first lens is fastened in the first position by an adhesive applied through an opening formed in the barrel.

7. The lens assembly of claim 1, wherein the second lens is fastened in the second position by an adhesive applied through an opening formed in the barrel.

8. The lens assembly of claim 1, wherein the spacer comprises stainless steel, nickel, brass, bronze, zinc, iron, copper, or titanium.

9. The lens assembly of claim 1, wherein the threshold level is 30 ppm/T.

10. A lens assembly, comprising:
a barrel;
a first lens positioned within the barrel, wherein the first lens has a first optically active portion having a first optical axis;
a second lens positioned within the barrel, wherein the second lens has a second optically active portion having a second optical axis that is aligned with the first optical axis; and
a spacer positioned between the first lens and the second lens, wherein the spacer comprises a material having a thermal expansion coefficient lower than a threshold level.

11. The lens assembly of claim 10, wherein the spacer includes at least one of titanium, nickel, brass, copper, or a combination thereof

12. The lens assembly of claim 10, wherein the threshold level is 30 ppm/T.

13. A method for providing a lens assembly, the method comprising:
fastening a first lens in a first position within a barrel;
positioning a spacer adjacent to the first lens; and
fastening a second lens in a second position adjacent to the spacer.

14. The method of claim 13, wherein the spacer comprises a material having a thermal expansion coefficient lower than a threshold level.

15. The method of claim 14, wherein the threshold level is 30 ppm/° C.

16. The method of claim 13, wherein fastening the first lens in the first position comprises applying an adhesive between the first lens and the barrel.

17. The method of claim 13, wherein fastening the second lens in the second position comprises applying an adhesive between the second lens and the barrel.

18. The method of claim 13, wherein fastening the first lens in the first position comprises welding the first lens to the barrel.

19. The method of claim 13, wherein fastening the second lens in the second position comprises welding the second lens to the barrel.

20. The method of claim 13, wherein fastening the first lens in the first position comprises applying an adhesive between the second lens and the barrel through an opening formed in a wall of the barrel.
